(19) United States
(12) Patent Application Publication
(10) Pub. No.: US 2009/0172290 A1
(43) Pub. Date: Jul. 2, 2009

(54) Replacing stored content to make room for additional content

(76) Inventors: Jason H. Wang, Gilbert, AZ (US); Kenneth Knowlson, Lake Owsego, OR (US)

Correspondence Address: TROP, PRUNER & HU, P.C., 1616 S. VOSS RD., SUITE 750, HOUSTON, TX, 77057-2631, US

(21) Appl. No.: 12/006,242

(22) Filed: Dec. 31, 2007

(51) Int. Cl. G06F 12/00

(52) U.S. Cl. 711/133; 711/E12.001

(57) ABSTRACT

The storage of items, such as media items, in a playback device may be managed automatically without user intervention in some embodiments. An algorithm, based on heuristics, may predict which items are most likely to be used or played in the future and, based on that determination, may select the least likely to be used items for replacement. In addition, replacement may be affected by the size of space needed for additional storage versus the size of particular candidates for replacement.

### BACKGROUND

This relates generally to the storage of content in other storage devices in which the amount of information to be stored may exceed the capacity of the storage device.

Media data, such as audio or video content, may be downloaded to playback devices such as televisions, cellular telephones, computers, set top boxes, cable receivers, and satellite television receivers, to mention a few examples. The amount of storage that these devices may accommodate may vary. In order to reduce their costs, it may be desirable to limit the amount of storage they have on board.

This creates the issue of what to do when the content which is to be downloaded exceeds the capacity of the storage system.

### BRIEF DESCRIPTION OF THE DRAWINGS

FIG. 1 is a schematic depiction of one embodiment; and

FIG. 2 is a flow chart showing a sequence that may be used by the server or client shown in FIG. 1, in accordance with some embodiments of the present invention.

### DETAILED DESCRIPTION

Some embodiments may apply to caching systems in which data is stored awhile on a storage device. Examples of such storage devices may be devices that cache frequently used information in computer systems. Other examples of such devices include storage devices that store downloaded content received from a higher capacity remote source. The storage device may be a playback device that receives content from a content server.

As one example, content may be received from a remote source such as a media server. The media server may have relatively large media items that users or clients may wish to receive. The client or user may download the first several minutes of each of a plurality of items from the media server and cache them within a local storage. Sometime later, the user may browse the downloaded items and may select items to play. The content may be played at the client by streaming the content from the local storage.

Eventually, the client starts to receive the rest of the content from the media server to augment the portion that was initially downloaded. Thus, at the same time content is being played back from the initially downloaded material, additional material may be downloaded, preferably at a faster than real time rate. The additionally downloaded material may append to the previously stored local file. Thus, when the end of the initially stored material is reached, additional material may already be downloaded to enable playback to continue.

Since the played media is also stored locally on the client, there may be situations that the media client runs out of local storage or nearly runs out of local storage. The media client then decides which of the already downloaded items to replace to free more storage for the more current media item to be downloaded.

In some embodiments of the present invention, a heuristic may be utilized to decide what to store. The heuristic has a number of characteristics in some embodiments. The heuristic may consider things other than the characteristics of the currently stored information or the information to be stored. It may receive information from outside the storage system. In some embodiments, the heuristic may also rely on information about how the information has been accessed in the past that is currently stored on the system. Finally, the heuristic may implement a comparison between certain features of items already stored on the system to determine which item should most advantageously be discarded.

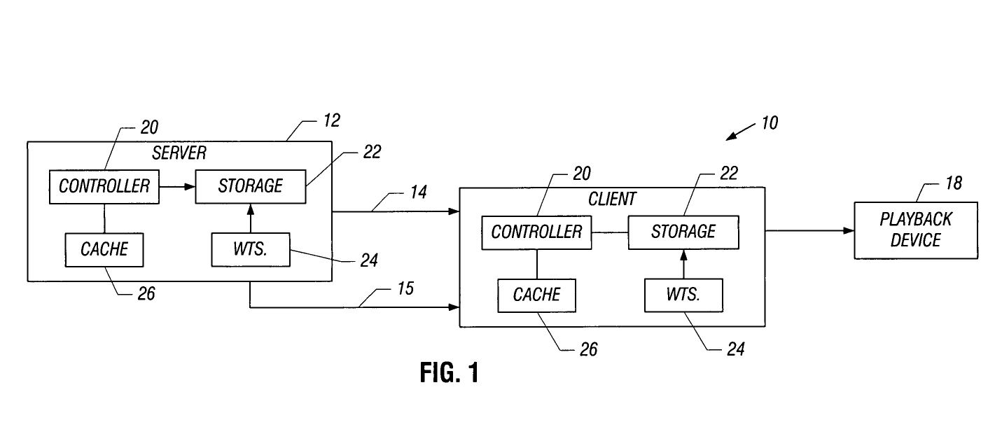

Referring to FIG. 1, a media distribution system 10 includes a server 12 or source of data to be provided over an appropriate connection 14 to a client or user of data 16. Thus, the server 12 may, for example, be a broadcast head end, a content server, a distributor of Internet information, a cellular telephone base station, a broadcast station, or a web server, to mention a few examples. The client 16 may, for example, be a cellular telephone, a computer, a cable box, a set top box, a satellite receiver, or a television, to mention a few examples. The client 16 may be coupled to a playback device 18 that actually plays the content that is received.

Both the server and the client may include a controller 20, such as a microprocessor, coupled to a storage 22. The storage 22 may store code, in some embodiments, to operate the system. In one embodiment, weighting software 24 may be stored on the storage 22 both in the server 12 and the client 16. Both of the server 12 and client 16, in some embodiments, may include a cache 26 that temporarily stores information. In the case of the server 12, the cache 26 may store frequently distributed information. In the case of the client 16, the cache 26 may store, for example, frequently received information or information that has relatively recently been received. However, the nature of the cache 26 and its uses are not critical and may be variable in different embodiments. Moreover, by the user of the term “cache 26,” it is not intended to designate any specific type of storage.

In some embodiments, in addition to the connection 14, a back channel connection 15 may be provided between the client and server to enable instructions, commands, and other less bulky information to be exchanged.

In order to determine what information to maintain in a cache 26, the assign weight sequence 24, which may software, hardware, or firmware, may be utilized. In some embodiments, it may be hardware within the server 12 or the client 16 or both. It may also be software stored in the storage 22 or it may be firmware included within the controller 20, to mention a few examples.

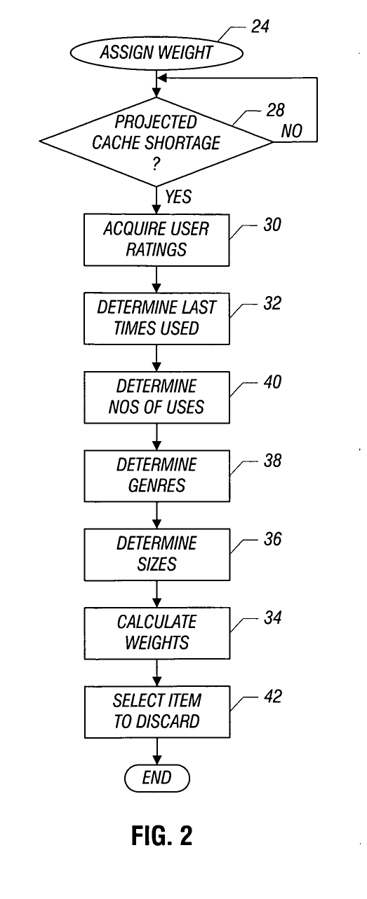

Continuing in FIG. 2, in some embodiments, a determination is made that the available capacity of the cache 26 is going to be exceeded based on the rate at which information is being stored in the cache or the amount of information known to be stored. When a projected cache shortage is detected at diamond 28, information is collected to enable a determination of what information should be discarded in order to make room for the incoming data.

Initially, at block 30, a user rating for each of a plurality of files presently stored on the system may be acquired in one embodiment. The system 10 may provide a way for users to explicitly assign ratings to any single stored item or set of stored items in a range that is defined within the system. In one embodiment, a higher rating may mean that a user uses the item more and probably is going to use the item again in the future.

In some embodiments, everything that is initially stored on the system may be rated at the low rating or the rating that indicates the highest desire to retain. The user can then change the rating manually, for example, through appropriate user interfaces. In some embodiments, the lower the rating an item has, the higher weight in the retention calculation and the more likely it is to be replaced. However, the opposite algorithm may be used as well.

If the user does not assign a user rating to any particular item in storage, then the rating may not have any affect on the replacement decision in some embodiments.

The ratings can be specific, in that there may be multiple client devices 16 used by the same users. For example, in one household, multiple devices may be provided in different rooms. The set of user ratings may be different for each such client 16.

Next, as indicated in block 32, the last time each item in storage is used may be determined.

The system 10 may also track (block 40) the number of times that items are played or used, either at the client 16 or, in some embodiments, anywhere on a network, which may include a large number of such clients 16. An adjustable time window may be used in this regard. In other words, instead of looking back through all time, items within a time window may be examined and, for example, the time window may be displaced some amount of time from the present time so that the most recently acquired items are exempt.

In some cases, the lower the number of uses, the higher the weight given in one calculation and, hence, the greater the likelihood the item will be replaced. However, the opposite arrangement may be used as well.

Next, the genre is determined, as indicated in block 38. In one embodiment, the system 10 may keep track of the genre, category or type of items that the user has received. The least used genres may be given higher weights in the calculation and, therefore, in one embodiment, may be more likely to be replaced.

Next, as indicated in block 36, the size of the items currently stored relative to the space needed may be determined. The system may calculate the size of each media item relative to the space needed, given the projected cache storage determined in diamond 28. If a device knows how much space is needed for new items, this may be used to prevent replacement of a large number of small media items. If the system wants to choose a single item that is big enough to hold the new item that may be advantageous in some embodiments.

Next, weights are assigned based on the above-identified criteria, as indicated in block 34. For a user rating r, the weight w(r) may be equal to r/max(r), where max(r) is the highest rating represented in number. For example, the weight for a 2 star media in a 5 star rating system may be ⅖ or 40%.

For the last time used (t), the time may be sorted in order from present to past, with the most recent one having 100% weight and the oldest one having 0% weight. All items in between may weigh equally. Thus, the weight may be determined as w(t)=(t−newest)/(oldest−newest).

The number of times watched (n) may be given a weight w(n)=(max(n)−n)/max(n), where max(n) is the maximum of times the item is used.

The genre score may be w(g)=(max(g)−g)/max(g), where max(g) is the maximum of the scores of the genre.

For the size of media item relative to space needed, the weight may be w(s)=s/max(s), where max(s) is the biggest size of any media item.

Then, a weight w may be calculated as equal to the average of:

(w(r), w(t), w(n), w(g), w(s))=(w(r)+w(t)+w(n)+w(g)+w(s))/5.

The media item with the highest w is then replaced when available room within the cache 26 is running out. The weighting of each factor may be adjusted. For example, a device manufactured may not assign a rating to the items and could weight one factor, such as user rating, less than all equally weighted. Once a media item is replaced, the metrics of that item may be reset to the default value. The algorithm can be extended to include any other number of factors.

In some embodiments, an algorithm automatically chooses the most appropriate items, such as media items, to replace. The calculation may be based on the user's usage of the media item and may predict the likelihood that the item is going to be used in the future. It chooses a media item for replacement that is most unlikely to be used again in the future. This may alleviate the burden that the user has in managing storage and, at the same time, may provide the best results for using the available storage capacity.

In some cases, as the user continues to use the system, the algorithm may improve over time. The device can predict more accurately based on the user's behavior over time and may be likely to choose the most appropriate item to replace.

The storage 22 may be implemented using any machine readable or computer readable media capable of storing data, including both volatile and non-volatile memory. For example, the storage 22 may include read only memory, random access memory, dynamic random access memory, double data rate dynamic random access memory, synchronous dynamic random access memory, static random access memory, programmable read only memory, erasable programmable read only memory, electrically erasable programmable read only memory, flash memory, polymer memory, ovonic memory, phase change or ferroelectric memory, or any other type of media suitable for storing information. All or part of the storage 22 may be included on the same integrated circuit as the controller 20 or, alternatively, some portion or all of the storage 22 may be disposed on an integrated circuit or other medium, for example a hard disk drive, that is external to the integrated circuit of the controller 20. The embodiments are not limited in this context.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining the likelihood that an item in storage will be used again in the future; and
using said likelihood to determine whether or not to discard the item to free additional storage space.

2. The method of claim 1 including using at least some information, not related to a characteristic of currently stored information, to determine whether or not to discard the item to free additional storage space.

3. The method of claim 1 including using at least some information from outside the system that includes the storage to determine what item to discard.

4. The method of claim 1 including using information about how information currently in the storage has been accessed in the past to determine whether or not to discard an item to free additional storage space.

5. The method of claim 1 including using said likelihood to determine whether or not to discard an item in response to an indication that the available storage space will be filled.

6. The method of claim 1 including using a user rating of items in said storage to decide which items to discard.

7. The method of claim 1 including determining the last time each of a plurality of items in said storage were last used and using that information to decide whether to discard the item.

8. The method of claim 1 including determining the number of times that each of a plurality of items in said storage has been used in the past and using that information to determine whether to discard an item.

9. A computer readable medium storing instructions that enable a processor-based system to:
determine the likelihood that item in a storage coupled to said processor will be used again in the future; and
using said likelihood to determine whether or not to discard the item to free additional storage space.

10. The medium of claim 9 further storing instructions to use at least some information, not related to a characteristic of currently stored information, to determine whether or not to discard the item to free additional storage space.

11. The medium of claim 9 further storing instructions to use at least some of the information from outside said system to determine what item to discard.

12. The medium of claim 9 further storing instructions to use information about how information is currently stored when said storage has been accessed in the past to determine whether or not to discard an item to free additional storage space.

13. The medium of claim 9 further storing instructions to use said likelihood to determine whether or not to discard an item in response to an indication that the available storage space will be filled.

14. The medium of claim 9 further storing instructions to use a user rating of items in said storage to decide which items to discard.

15. The medium of claim 9 further storing instructions to determine the number of times that each of a plurality of items in said storage has been used in the past and to use that information to determine whether to discard an item.

16. The medium of claim 9 further storing instructions to compare the size of space needed for additional storage within said storage and the size of items in said storage to determine which item to discard.

17. An apparatus comprising:
a controller;
a storage coupled to said controller; and
said controller to determine the likelihood that an item in said storage will be used again in the future and use said likelihood to determine whether or not to discard the item to free additional storage space.

18. The apparatus of claim 17 wherein said storage is a cache memory.

19. The apparatus of claim 17, said controller to use a user rating to access which item to discard.

20. The apparatus of claim 17 wherein said apparatus is a media client.
